(19) United States
(12) Patent Application Publication
(10) Pub. No.: US 2013/0058421 A1
(43) Pub. Date: Mar. 7, 2013

(54) METHODS AND APPARATUS FOR ADAPTIVE DIRECTIONAL FILTER FOR VIDEO RESTORATION

(71) Applicants: Yunfei Zheng, San Diego, CA (US); Qian Xu, Folsom, CA (US); Peng Yin, Ithaca, NY (US); Xiaoan Lu, Princeton, NJ (US); Joel Sole, La Jolla, CA (US)

(72) Inventors: Yunfei Zheng, San Diego, CA (US); Qian Xu, Folsom, CA (US); Peng Yin, Ithaca, NY (US); Xiaoan Lu, Princeton, NJ (US); Joel Sole, La Jolla, CA (US)

(73) Assignee: Thomson Licensing, Issy de Moulineaux (FR)

(21) Appl. No.: 13/698,118

(22) PCT Filed: May 11, 2011
(86) PCT No.: PCT/US11/00832

§ 371 Date: Nov. 15, 2012

Related U.S. Application Data
(60) Provisional application No. 61/345,407, filed on May 17, 2010.

(51) Int. Cl. H04N 7/26

(52) U.S. Cl. 375/240.25; 375/240.01; 375/E07.027

(57) ABSTRACT

Methods and apparatus are provided for an adaptive directional filter for video restoration. An apparatus includes a video encoder for encoding at least a portion of a picture by categorizing pixels in the portion into respective ones of a plurality of groups, and selecting on a pixel basis filtering parameters for filtering the pixels responsive to the respective ones of the plurality of groups to which the pixels belong.

### CROSS-REFERENCE TO RELATED APPLICATIONS

This application claims the benefit of U.S. Provisional Application Ser. No. 61/345,407, filed May 17, 2010, which is incorporated by reference herein in its entirety.

### TECHNICAL FIELD

The present principles relate generally to video encoding and decoding and, more particularly, to methods and apparatus for an adaptive directional filter for video restoration.

### BACKGROUND

Video coding standards employ block-based transforms (e.g., discrete cosine transforms (DCTs)) and motion compensation to achieve compression efficiency. Due to the lossy-compression property of the framework, the quality of the reconstructed videos will be degraded. In a hybrid video coding framework, filtering techniques are often used to remove compression artifacts or distortion for the purpose of obtaining higher quality video frames for displaying or serving as references for other frames. These filters can be implemented as in-loop or out-of-loop in many video compression applications. Due to the changing nature and characteristics of the images which include video signals, the filtering processes are often adaptive in both spatial and temporal domains.

In the International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”), a deblocking filter is applied to the decoded picture for removing blocky artifacts. In the Key Technology Area (KTA) of the MPEG-4 AVC Standard, Wiener filters are used in-loop or out-of-loop to improve the quality of the decoded pictures. To achieve the temporal adaptation, a filter (for example, a Wiener filter) is usually estimated for each picture by minimizing the mean square error between the original picture and the decoded picture at the encoder. The filter coefficients are sent to the decoder as the overhead for each picture. To achieve spatial adaptation, a picture is partitioned into multiple regions based on content or rate-distortion (RD) cost. In each region, a switch controls the filtering process on or off. The region partition information and the switch control message are sent to decoder as the side information.

This approach works well for non-stationary video signals. The region partitions are either equally-sized or variably-sized blocks. However, with only one filter estimated per picture, the block-based switching methods cannot effectively characterize the spatial variations within the natural image and videos. In the extreme case, each pixel should have a different optimal restoration filter. The filter estimated by mixing all pixels is just optimal in the average sense. For each pixel, it is far from optimal and sometimes can degrade the picture quality. However, if a filter is transmitted to a decoder for each pixel, the overhead cost would eat up all the performance brought by the picture restoration process.

### Post Filter in KTA

In the Key Technology Area (KTA) of the MPEG-4 AVC Standard, an adaptive post filter was proposed in a first prior art approach. The basic idea is to apply a Wiener filter to the decoded picture before display. The Wiener filter can be estimated for each picture by minimizing the mean square error (MSE) between the original picture and the decoded picture at the encoder. In this case, the estimated filter coefficients are sent to the decoder as overhead. The whole picture is filtered with the estimated filter. In another case, a set of Wiener filters are trained offline, transmitted to or stored at the decoder. During decoding, the picture is filtered pixel-wise. At each pixel, a filter is selected from the filter set based on the statistics of the surrounding pixels. In this technique, the filtering indicator does not cost any overhead. The filtering indicator can be derived by the decoded picture content. However, a model between the filtering indicator and the picture content is very hard to build. In the first prior art approach, an offline training scheme is exploited to find the corresponding model between the filtering indicator and the local variance. Since the training is highly dependent on the training set, a model trained with limited data will be inaccurate for more general video signals.

### Adaptive Loop Filter

In a second prior art approach, a block-based adaptive loop filter is proposed. In the second prior art approach, a reconstructed frame is restored by a Wiener filter towards the original frame. The Wiener filter coefficients are estimated at the encoder and sent to the decoder as side information. Although a Wiener filter can restore the reconstructed frame to the original frame globally, there are degraded pixels locally because the filter is optimized in an average mean square error sense. Since the degraded areas reduce either the predictive efficiency for future coding frames or the visual quality of the picture, not filtering these areas will improve the coding performance and subjective quality. In a block adaptive loop filter (BALF), a frame is partitioned into equal-sized blocks, and a switch flag for each block is used to control whether or not the block is filtered. In the second prior art approach, a quad-tree adaptive loop filter (QALF) is introduced to indicate whether or not a variable-size block of a frame is filtered. When using the variable-sized block scheme, the overhead for coding the size and location of blocks would be demanding although the filter performance is better than the equal-sized block scheme. However, even quad-tree based filtering still does not efficiently remove compression artifacts, as it is unable to capture the spatial characteristics of two-dimensional (2D) data with only one filter for the whole picture.

In a third prior art approach, a set of M filters is proposed instead of a single filter as used in the QALF approach. The set of M filters is transmitted to the decoder for each picture or a group of pictures (GOP). Whenever the QALF segmentation map indicates that a block should be filtered, for each pixel in that block, a specific filter from the set is chosen based on a measure of local characteristic of an image, called an activity measure, which is the sum-modified Laplacian measure. Although it uses multiple filters, the filter selection criteria for a specific pixel is not dependent on the pixel orientation as the activity measure has no directional characteristics. As used herein, the phrase “pixel orientation” refers to the slope of an edge (or imaginary line) running through the picture which characterizes a boundary of pixels having similar luma, chroma, and geometric characteristics. Moreover, the filter support does not adapt to the pixel orientation. Turning to FIG. 1, an example of filter support without adaptation to pixel orientation is indicated generally by the reference numeral 100. The example involves a filter support 110, an anisotropic pixel 120, and an isotropic pixel 130. The filter support 110 may also mix the pixels in different orientations for filter estimation, which is not preferred since it is well known that filtering along the pixel orientation is one of the most efficient ways to exploit the spatial correlations between pixels.

On the other hand, the above approaches usually use one non-separable 2D filter or multiple non-separable 2D filters as the filter estimation is simple while considering the performance. Although it is simple for filter estimation and good for performance, a non-separable filter is not desirable for software speedup or hardware implementations. A 2D separable filter is also proposed in a fourth prior art approach and a fifth prior art approach.

In the fourth prior art approach, horizontal and vertical filters are estimated sequentially with filter support along horizontal and vertical. In the fifth prior art approach, the horizontal and vertical filters are estimated by approximating a 2D non-separable filter. Although these approaches are simple, the performance is far from optimal and the complexity is not dramatically reduced as they still need to filter a picture twice, in the horizontal and vertical directions.

### SUMMARY

These and other drawbacks and disadvantages of the prior art are addressed by the present principles, which are directed to methods and apparatus for an adaptive directional filter for video restoration.

According to an aspect of the present principles, there is provided an apparatus. The apparatus includes a video encoder for encoding at least a portion of a picture by categorizing pixels in the portion into respective ones of a plurality of groups, and selecting on a pixel basis filtering parameters for filtering the pixels responsive to the respective ones of the plurality of groups to which the pixels belong.

According to another aspect of the present principles, there is provided a method in a video encoder. The method includes encoding at least a portion of a picture. The encoding step includes categorizing pixels in the portion into respective ones of a plurality of groups, and selecting on a pixel basis filtering parameters for filtering the pixels responsive to the respective ones of the plurality of groups to which the pixels belong.

According to yet another aspect of the present principles, there is provided an apparatus. The apparatus includes a video decoder for decoding at least a portion of a picture by categorizing pixels in the portion into respective ones of a plurality of groups, and determining on a pixel basis filtering parameters for filtering the pixels responsive to the respective ones of the plurality of groups to which the pixels belong.

According to still another aspect of the present principles, there is provided a method in a video decoder. The method includes decoding at least a portion of a picture. The decoding step includes categorizing pixels in the portion into respective ones of a plurality of groups, and determining on a pixel basis filtering parameters for filtering the pixels responsive to the respective ones of the plurality of groups to which the pixels belong.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing an example of filter support without adaptation to pixel orientation, according to the prior art;

FIG. 2 is a block diagram showing an exemplary video encoder to which the present principles may be applied, in accordance with an embodiment of the present principles;

FIG. 3 is a block diagram showing an exemplary video decoder to which the present principles may be applied, in accordance with an embodiment of the present principles;

FIG. 4 is a diagram showing exemplary filter support with adaptation to pixel orientation, in accordance with an embodiment of the present principles;

FIGS. 5A-5H are diagrams showing filter support in various orientations, in accordance with an embodiment of the present principles;

FIG. 6 is a flow diagram showing an exemplary method for adaptive directional filtering in a video encoder, in accordance with an embodiment of the present principles;

FIG. 7 is a flow diagram showing an exemplary method for adaptive directional filtering in a video decoder, in accordance with an embodiment of the present principles;

FIG. 8 is a flow diagram showing another exemplary method for adaptive directional filtering in a video encoder, in accordance with an embodiment of the present principles; and

FIG. 9 is a flow diagram showing another exemplary method for adaptive directional filtering in a video decoder, in accordance with an embodiment of the present principles.

### DETAILED DESCRIPTION

The present principles are directed to methods and apparatus for an adaptive directional filter for video restoration.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Additionally, as used herein, the words “pixel basis” refer to doing something (e.g., selecting filtering parameters) on a pixel level. That is, each pixel is individually considered when determining, for example, the filtering parameters for the filtering that is to be applied to that pixel. Similarly, the words “on a frame basis” and “on a group of pictures (GOP) basis” refer to doing something on a frame level and a group of pictures level respectively. That is, for example, for a video sequence having a plurality of frames, filter parameters may be estimated for each frame individually. Correspondingly, for a video sequence having a plurality of groups of pictures, filter parameters may be estimated for each group of pictures individually.

For purposes of illustration and description, examples are described herein in the context of improvements over the MPEG-4 AVC Standard, using the MPEG-4 AVC Standard as the baseline for our description and explaining the improvements and extensions beyond the MPEG-4 AVC Standard. However, it is to be appreciated that the present principles are not limited solely to the MPEG-4 AVC Standard and/or extensions thereof. Given the teachings of the present principles provided herein, one of ordinary skill in this and related arts would readily understand that the present principles are equally applicable and would provide at least similar benefits when applied to extensions of other standards, or when applied and/or incorporated within standards not yet developed. It is to be further appreciated that the present principles also apply to video encoders and video decoders that do not conform to standards, but rather confirm to proprietary definitions.

As used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, Picture Parameter Set (PPS) level, Sequence Parameter Set (SPS) level and Network Abstraction Layer (NAL) unit header level.

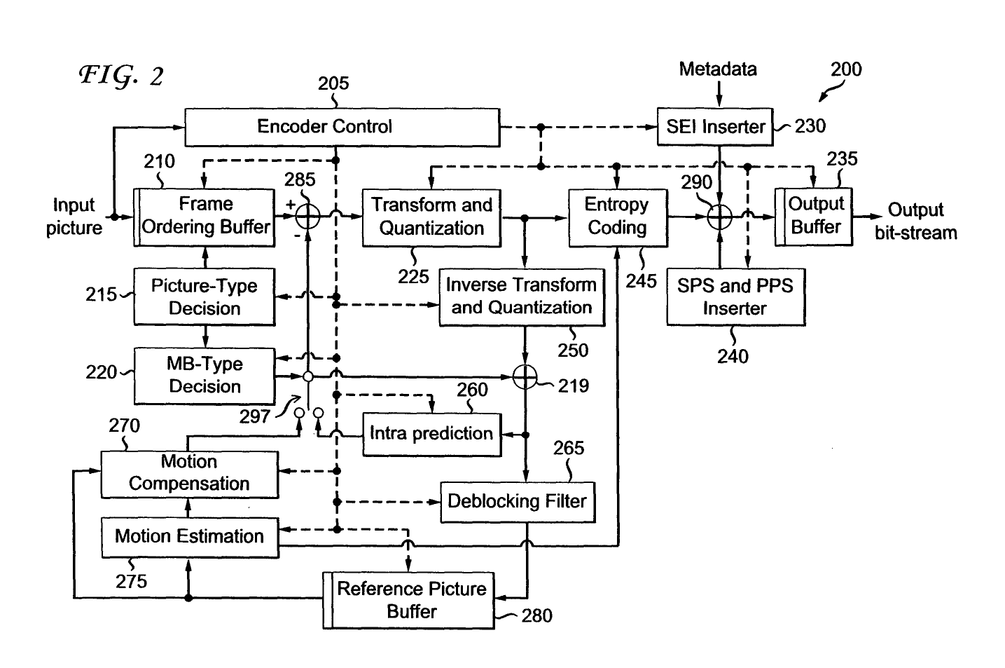

Turning to FIG. 2, an exemplary video encoder to which the present principles may be applied is indicated generally by the reference numeral 200. The video encoder 200 includes a frame ordering buffer 210 having an output in signal communication with a non-inverting input of a combiner 285. An output of the combiner 285 is connected in signal communication with a first input of a transformer and quantizer 225. An output of the transformer and quantizer 225 is connected in signal communication with a first input of an entropy coder 245 and a first input of an inverse transformer and inverse quantizer 250. An output of the entropy coder 245 is connected in signal communication with a first non-inverting input of a combiner 290. An output of the combiner 290 is connected in signal communication with a first input of an output buffer 235.

A first output of an encoder controller 205 is connected in signal communication with a second input of the frame ordering buffer 210, a second input of the inverse transformer and inverse quantizer 250, an input of a picture-type decision module 215, a first input of a macroblock-type (MB-type) decision module 220, a second input of an intra prediction module 260, a second input of a deblocking filter 265, a first input of a motion compensator 270, a first input of a motion estimator 275, and a second input of a reference picture buffer 280.

A second output of the encoder controller 205 is connected in signal communication with a first input of a Supplemental Enhancement Information (SEI) inserter 230, a second input of the transformer and quantizer 225, a second input of the entropy coder 245, a second input of the output buffer 235, and an input of the Sequence Parameter Set (SPS) and Picture Parameter Set (PPS) inserter 240.

An output of the SEI inserter 230 is connected in signal communication with a second non-inverting input of the combiner 290.

A first output of the picture-type decision module 215 is connected in signal communication with a third input of the frame ordering buffer 210. A second output of the picture-type decision module 215 is connected in signal communication with a second input of a macroblock-type decision module 220.

An output of the Sequence Parameter Set (SPS) and Picture Parameter Set (PPS) inserter 240 is connected in signal communication with a third non-inverting input of the combiner 290.

An output of the inverse quantizer and inverse transformer 250 is connected in signal communication with a first non-inverting input of a combiner 219. An output of the combiner 219 is connected in signal communication with a first input of the intra prediction module 260 and a first input of the deblocking filter 265. An output of the deblocking filter 265 is connected in signal communication with a first input of a reference picture buffer 280. An output of the reference picture buffer 280 is connected in signal communication with a second input of the motion estimator 275 and a third input of the motion compensator 270. A first output of the motion estimator 275 is connected in signal communication with a second input of the motion compensator 270. A second output of the motion estimator 275 is connected in signal communication with a third input of the entropy coder 245.

An output of the motion compensator 270 is connected in signal communication with a first input of a switch 297. An output of the intra prediction module 160 is connected in signal communication with a second input of the switch 297. An output of the macroblock-type decision module 220 is connected in signal communication with a third input of the switch 297. The third input of the switch 297 determines whether or not the “data” input of the switch (as compared to the control input, i.e., the third input) is to be provided by the motion compensator 270 or the intra prediction module 260. The output of the switch 297 is connected in signal communication with a second non-inverting input of the combiner 219 and an inverting input of the combiner 285.

A first input of the frame ordering buffer 210 and an input of the encoder controller 205 are available as inputs of the encoder 200, for receiving an input picture. Moreover, a second input of the Supplemental Enhancement Information (SEI) inserter 230 is available as an input of the encoder 200, for receiving metadata. An output of the output buffer 235 is available as an output of the encoder 200, for outputting a bitstream.

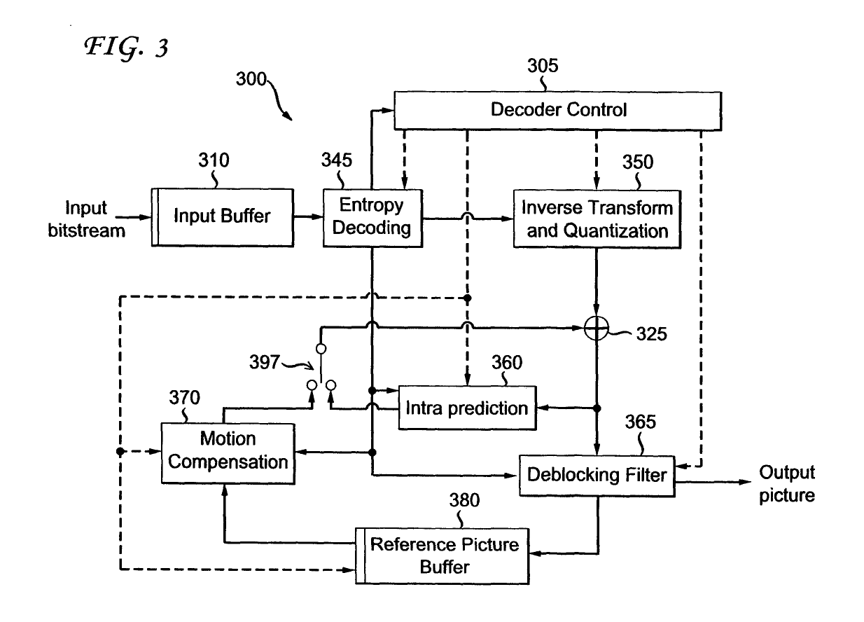

Turning to FIG. 3, an exemplary video decoder to which the present principles may be applied is indicated generally by the reference numeral 300. The video decoder 300 includes an input buffer 310 having an output connected in signal communication with a first input of an entropy decoder 345. A first output of the entropy decoder 345 is connected in signal communication with a first input of an inverse transformer and inverse quantizer 350. An output of the inverse transformer and inverse quantizer 350 is connected in signal communication with a second non-inverting input of a combiner 325. An output of the combiner 325 is connected in signal communication with a second input of a deblocking filter 365 and a first input of an intra prediction module 360. A second output of the deblocking filter 365 is connected in signal communication with a first input of a reference picture buffer 380. An output of the reference picture buffer 380 is connected in signal communication with a second input of a motion compensator 370.

A second output of the entropy decoder 345 is connected in signal communication with a third input of the motion compensator 370, a first input of the deblocking filter 365, and a third input of the intra predictor 360. A third output of the entropy decoder 345 is connected in signal communication with an input of a decoder controller 305. A first output of the decoder controller 305 is connected in signal communication with a second input of the entropy decoder 345. A second output of the decoder controller 305 is connected in signal communication with a second input of the inverse transformer and inverse quantizer 350. A third output of the decoder controller 305 is connected in signal communication with a third input of the deblocking filter 365. A fourth output of the decoder controller 305 is connected in signal communication with a second input of the intra prediction module 360, a first input of the motion compensator 370, and a second input of the reference picture buffer 380.

An output of the motion compensator 370 is connected in signal communication with a first input of a switch 397. An output of the intra prediction module 360 is connected in signal communication with a second input of the switch 397. An output of the switch 397 is connected in signal communication with a first non-inverting input of the combiner 325.

An input of the input buffer 310 is available as an input of the decoder 300, for receiving an input bitstream. A first output of the deblocking filter 365 is available as an output of the decoder 300, for outputting an output picture.

As noted above, the present principles are directed to methods and apparatus for an adaptive directional filter for video restoration. In particular, the present principles relate to a classification-based directional adaptive filter to improve video coding performance

In summary, many block-based adaptive filters have recently been proposed to achieve spatial and temporal adaptation with increasing complexity at both the encoder and the decoder. In accordance with the present principles, we disclose and describe a directional spatiotemporal adaptive filtering scheme to improve the coding performance with very little increase in complexity. Specifically, the orientation of each pixel in a video picture is detected. Then, pixels are categorized based on their orientation. Fortunately, the optimal filters for pixels having the same or similar orientations usually show similar characteristics. For example, their frequency responses show the obvious orientation perpendicular to the pixel orientation. Thus, in accordance with the present principles, we use orientation as a feature to classify the pixels into different orientation categories. For each category, we will estimate the optimal filter based on some specified or discernable criteria. Then the estimated filter will be applied to the pixels in the corresponding category. This approach achieves a good trade-off between the performance and the overhead cost, because only several (but regardless, a small number) filter coefficients need to be transmitted to the decoder. We also disclose and describe a scheme for adapting the filter structure to the orientation in order to reduce the complexity at both the encoder and the decoder.

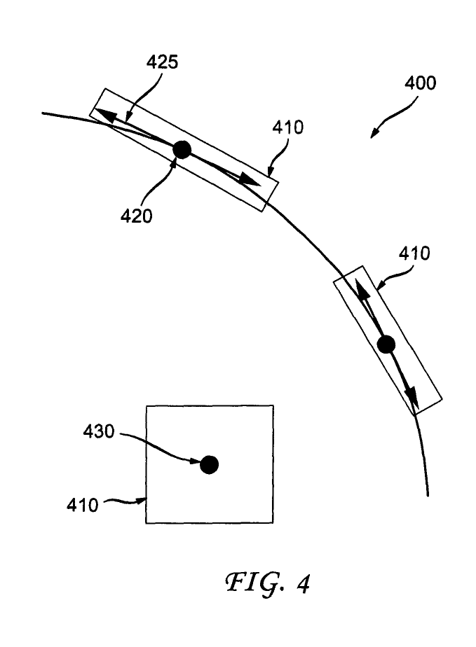

The basic idea is to extract the orientation information of each pixel first. Then the pixels in the picture are classified into multiple categories based on the orientation information extracted before. A directional filter is estimated for each pixel category by exploiting the orientation information. Specifically, the topology of the filter support adapts the pixel orientation. Finally, a pixel is filtered by its corresponding filter that is estimated by using the pixels in the same category. The approach can also be combined with the QALF approach to enable or disable filtering for each region. The orientation information can be extracted using any information of a picture such as, for example, Gaussian Structure Tensor (GST), gradient, variance, Laplacian measurement, and so forth. Turning to FIG. 4, exemplary filter support with adaptation to pixel orientation is indicated generally by the reference numeral 400. The example involves a filter support 410, an anisotropic pixel 420, a pixel orientation 425 of the anisotropic pixel 420, and an isotropic pixel 430.

### EMBODIMENT 1

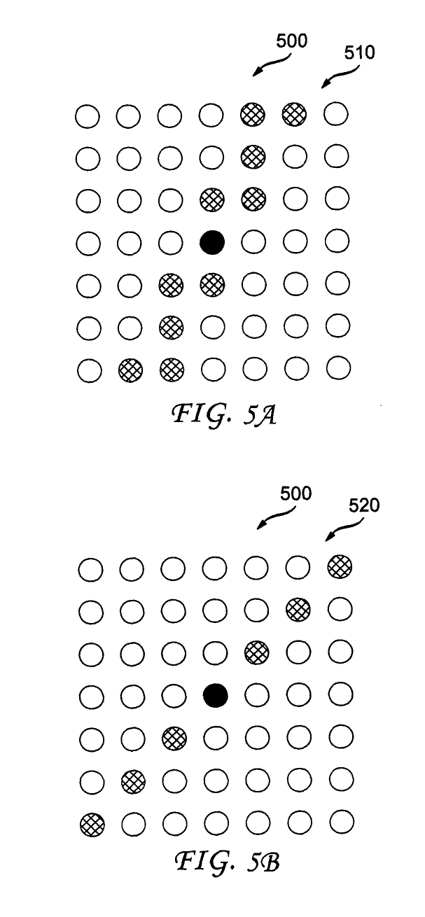

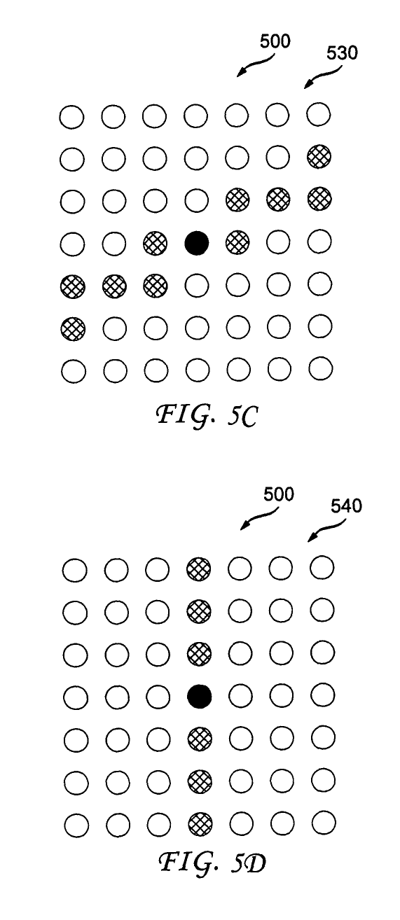

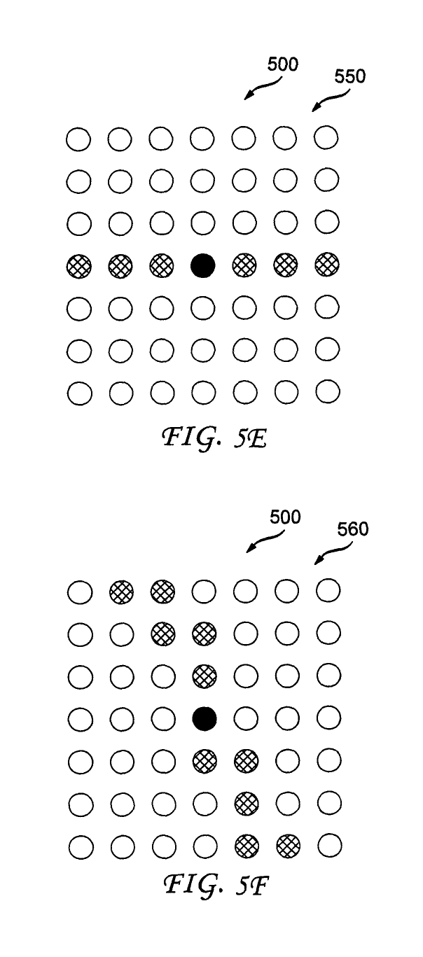

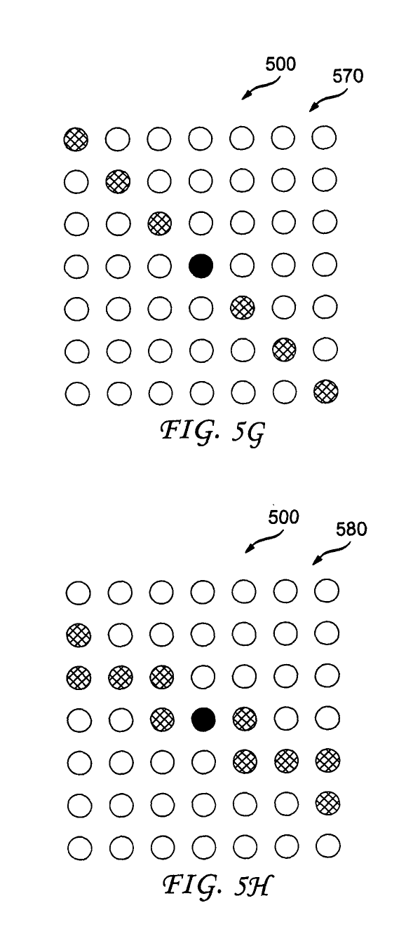

In one embodiment (hereinafter “Embodiment 1”), orientation is estimated for all pixels over the input picture to be filtered. Pixels that are determined as anisotropic are further classified into different categories based on the orientations. Other pixels that are determined as isotropic pixels will be classified to one category. For each category, a set of filter coefficients are computed by minimizing a criteria (e.g., mean square error) relating to pixels between the original picture and the reconstructed picture within this category. The filter coefficients for each category can be estimated frame by frame or GOP by GOP adaptively and signaled using a high level syntax. The coefficients can be differentially coded within a picture or using the coefficients from previous pictures. Alternatively, to save the signaling overhead, the coefficients can be estimated offline with a set of data and be stored at both the encoder and the decoder. For pixels in the rest of picture that are not determined as anisotropic pixels, another set of filter coefficients are computed before filtering. At the decoder, similar orientation extraction and classification are performed over the picture before filtering. During the filter estimation, the topology of filter support is defined along the corresponding orientation of the category if the category is for the anisotropic pixels, which makes the filter with high directional dependence. Turning to FIGS. 5A-5H, filter support in various orientations is indicated generally by the reference numeral 500. In FIGS. 5A-5H, filled-in pixels represent pixels that need to be filtered, cross-hatched pixels represent pixels in the filter support, and completely un-filled pixels represent pixels outside the filter support. FIG. 5A corresponds to an orientation of 67.5 degrees, denoted by the reference numeral 510. FIG. 5B corresponds to an orientation of 45 degrees, denoted by the reference numeral 520. FIG. 5C corresponds to an orientation of 22.5 degrees, denoted by the reference numeral 530. FIG. 5D corresponds to an orientation of 90 degrees, denoted by the reference numeral 540. FIG. 5E corresponds to an orientation of 0 degrees, denoted by the reference numeral 550. FIG. 5F corresponds to an orientation of −67-5 degrees, denoted by the reference numeral 560. FIG. 5G corresponds to an orientation of −45 degrees, denoted by the reference numeral 570. FIG. 5H corresponds to an orientation of −22.5 degrees, denoted by the reference numeral 580. For the isotropic pixel category, filter support can be isotropic. In each category, the filter taps can also be different, for example in

FIG. 3, filters in 0, ±45, and 90 degree orientations have different support length than those in ±22.5 and ±67.5 degree orientations. The proposed directional filter can be applied to luma components and/or chroma components.

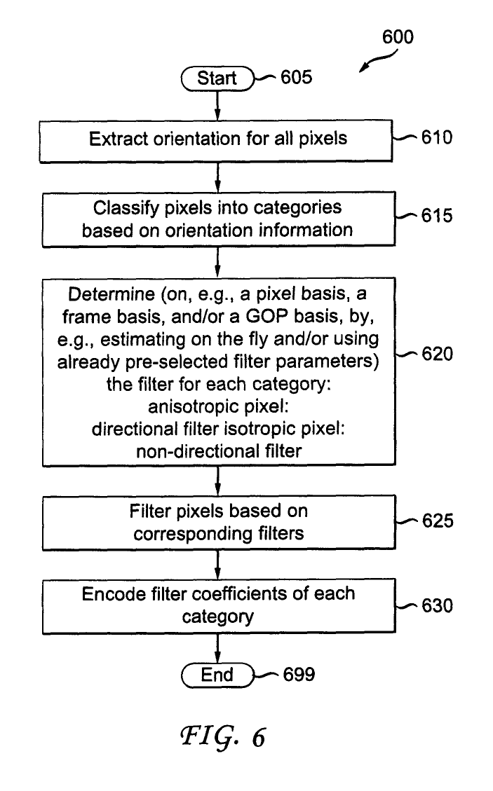

Turning to FIG. 6, an exemplary method for adaptive directional filtering in a video encoder is indicated generally by the reference numeral 600. The method 600 includes a start block 605 that passes control to a function block 610. The function block 610 extracts the orientation for all pixels, and passes control to a function block 615. The function block 615 classifies pixels into categories based on orientation information, and passes control to a function block 620. The function block 620 determines (e.g., on a pixel basis, a frame basis, and/or a GOP basis, by, e.g., estimating on the fly and/or using already pre-selected filtering parameters) the filter for each category, and passes control to a function block 625. Regarding the function block 620, as an example, a directional filter is estimated for anisotropic pixels, while a non-directional filter is estimated for isotropic pixels. The function block 625 filters pixels based on corresponding filters, and passes control to a function block 630. The function block 630 encodes filter coefficients for each category, and passes control to an end block 699.

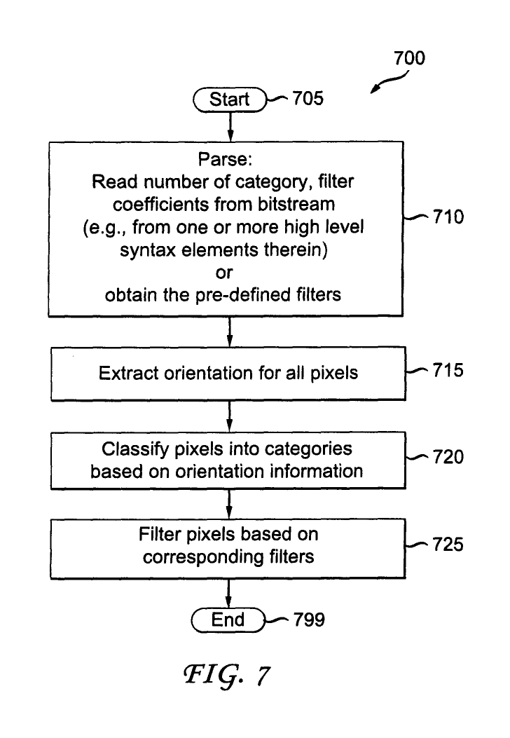

Turning to FIG. 7, an exemplary method for adaptive directional filtering in a video decoder is indicated generally by the reference numeral 700. The method 700 includes a start block 705 that passes control to a function block 710. The function block 710 performs parsing, including reading the number of categories and the filter coefficients from the bitstream or obtaining the pre-defined filters, and passes control to a function block 715. That is, regarding function block 710, either the parsing is performed or the pre-defined filters are obtained. The function block 715 extracts the orientation for all pixels, and passes control to a function block 720. The function block 720 classifies pixels into categories based on orientation information, and passes control to a function block 725. The function block 725 filters pixels based on corresponding filters, and passes control to an end block 799.

We will now describe in further detail an example of how filtering is performed in accordance with Embodiment 1. In the example, we use a set of M filters. The set of M filters is signaled at the slice header level and will be transmitted to the decoder. The filter coefficients are differentially coded within a slice. Accordingly, the pixels are classified into M categories. We use the Gaussian Structure Tensor (GST) as a measure as shown below. Presuming we are processing an image 1, the Structure Tensor is defined as follows:

$$S ( i , j ) = [ \begin{matrix}{I}_{x}^{2} & {I}_{x} \cdot {I}_{y} \\ {I}_{x} \cdot {I}_{y} & {I}_{y}^{2}\end{matrix} ] \qquad ( 1 )$$

where Iₓ and I_{y} are the first order derivatives of image I at pixel (i, j). With the robustness consideration, we consider an NxN neighborhood, we filtered the derivatives Iₓ and I_{y} with a pre-defined Gaussian filter. The Gaussian Structure Tensor is defined as follows:

$$S ( i , j ) = [ \begin{matrix}{\sum }_{k ∈ NxN}^{ } w ( k ) {{l}_{x} ( k )}^{2} & {\sum }_{k ∈ NxN}^{ } w ( k ) {l}_{x} ( k ) \cdot {I}_{y} ( k ) \\ {\sum }_{k ∈ NxN}^{ } w ( k ) {l}_{x} ( k ) \cdot {I}_{y} ( k ) & {\sum }_{k ∈ NxN}^{ } w ( k ) {{l}_{y} ( k )}^{2}\end{matrix} ] = [ \begin{matrix}a & b \\ c & d\end{matrix} ] \qquad ( 2 )$$

where w(k) is the coefficient of the pre-defined Gaussian filter. Presuming the two eigenvalues of S(i, j) are λ₁ and λ₂ (λ₁>λ₂), anisotropy A(i, j), which is used to measure if the pixel has an obvious orientation, is defined as follows:

$$A ( i , j ) = \frac{{( {λ}_{1} - {λ}_{2} )}^{2}}{{( {λ}_{1} + {λ}_{2} )}^{2}} = 1 + 4 \frac{( {b}^{2} - ac )}{{( a + c )}^{2}} \qquad ( 3 )$$

If a pixel has a high anisotropy value, then the eigenvector v of S(i, j) corresponding to the largest eigenvalue (λ₁) implies the dominant orientation of the pixel (i, j) as follows:

$$v = {[ 1 \frac{{λ}_{1} - a}{b} ]}^{T} \qquad ( 4 )$$

The orientation of the pixel is as follows:

$$θ = a tan ( \frac{{λ}_{1} - a}{b} ) \qquad ( 5 )$$

We can divide the orientation space (−90°˜+90 °) into several slots. Each slot corresponds to an orientation category. In this example, there are 8 slots for 8 different orientation categories. The orientation is a multiple of 22.5 degrees. The filter support topology is 7×7 in this example as shown in FIGS. 5A-5H. The filter taps are different in different categories.

Based on the above orientation extraction approach, we can classify the pixels into anisotropic and isotropic pixels by thresholding the anisotropy value A in Equation (3). If the anisotropy value A of a pixel is larger than some threshold, it is an anisotropic pixel.

Otherwise, the anisotropy value A of the pixel will be smaller than or equal to the threshold and the pixel will be considered an isotropic pixel. All isotropic pixels are classified into one category. Anisotropic pixels are classified into different categories based on the orientation 0 in Equation (5).

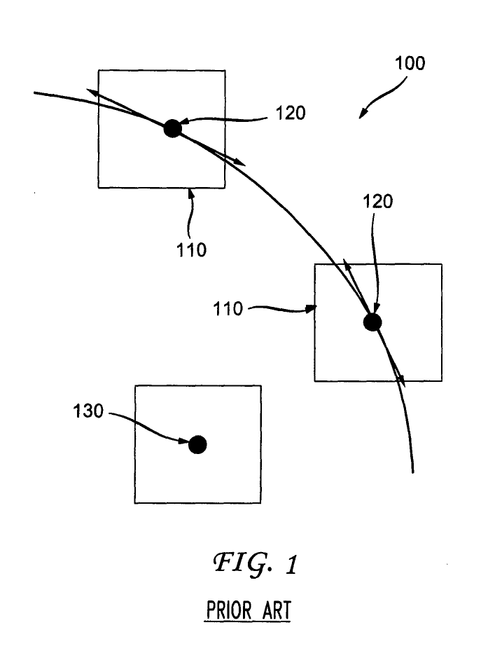

For each category which has the number of pixels larger than a threshold, we will estimate a filter corresponding to the orientation. Otherwise, the pixels in the category will be merged into the neighboring orientation categories. The filter is estimated by minimizing the mean square error (MSE) between the original pixel and the filtered pixel within the category. The filter supports for the anisotropic pixels are defined by FIGS. 5A-5H. In an embodiment, the filter support for isotropic pixels is defined as in FIG. 1. Of course, other filter supports may be used for the anisotropic pixels, as well as the isotropic pixels, while maintaining the spirit of the present principles.

### Encoding Algorithm

1. Preprocess the input picture for better orientation extraction.

2. Calculate the anisotropy A of each pixel of the input picture.

3. Classify the pixels into the anisotropic category or the isotropic category by comparing the anisotropy value A with a pre-set threshold.

4. Calculate the orientation 6 of the anisotropic pixels.

5. Classify the anisotropic pixels into different orientation categories based on the orientation 6.

6. Estimate the filter for each category with the pre-set filter support topology.

7. Filter the pixels with the corresponding filter.

8. Transmit the syntax and filter coefficients to the decoder.

### Decoding Algorithm

1. Parse the syntax and filter coefficients for each category.

2. Preprocess the input picture for better orientation extraction.

3. Calculate the anisotropy A of each pixel of the input picture.

4. Classify the pixels into the anisotropic category or the isotropic category by comparing the anisotropy value A with a pre-set threshold.

5. Calculate the orientation 9 of the anisotropic pixels.

6. Classify the anisotropic pixels into different orientation categories based on the orientation 9.

7. Filter the pixels with the corresponding filter.

### Syntax

TABLE 1 shows exemplary slice header syntax, in accordance with an embodiment of the present principles.

TABLE 1

| slice_header( ) { | Descriptor |
|---|---|
| ... | |
| directional_filter_flag | u(1) |
| if (edge_filter_flag==1){ | |
| num_of_orientation | u(v) |
| for (i=0; i<num_edge_dir; i++){ | |
| orientation_used_flag [i] | u(1) |
| if (edge_dir_used_flag[i] == 1){ | |
| num_of_coeff [i] | u(v) |
| for (j=0; j<num_of_coeff[i]; j++) { | |
| filter_coeff[i][j] | u(v) |
| } | |
| } | |
| } | |
| } | |
| ... | |
| } | |

The semantics of some of the syntax elements shown in TABLE 1 are as follows:
directional_filter_flag equal to 1 specifies that classification based adaptive directional filtering is used for the slice. directional_filter_flag equal to 0 specifies that classification based adaptive directional filtering is not used.
num_of_orientation specifies the total number of pixel orientations.
orientation_used_flag[i] equal to 1 specifies that the filter in the i^{th} orientation is used. orientation_used_flag[i] equal to 0 specifies that the filter in the i^{th} orientation is not used.
num_of_coeff[i] specifies the number of filter coefficients for the i^{th} orientation.
filter_coeff[i][j] specifies the j^{th} coefficient for the filter in the i^{th} direction.

### EMBODIMENT 2

In another embodiment, the classification-based adaptive directional filtering is combined with BALF or QALF, which decides for each pixel whether or not to filter. If BALF or QALF decides to filter a block, the pixels will be filtered with the specific filter for the categories to which the pixels belong.

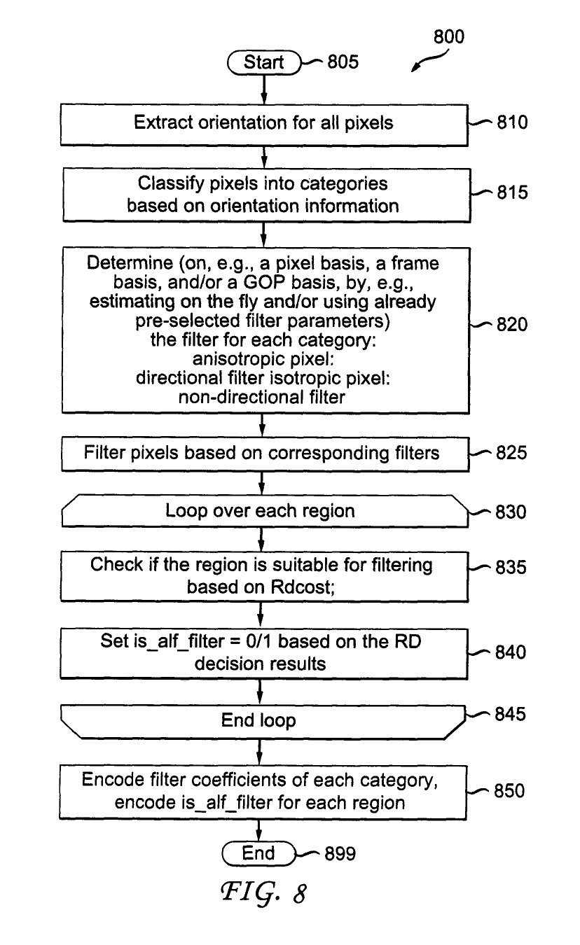

Turning to FIG. 8, another exemplary method for adaptive directional filtering in a video encoder is indicated generally by the reference numeral 800. The method 800 includes a start block 805 that passes control to a function block 810. The function block 810 extracts pixel orientations for all pixels, and passes control to a function block 815. The function block 815 classifies pixels into categories based on orientation information, and passes control to a function block 820. The function block 820 620 determines (e.g., on a pixel basis, a frame basis, and/or a GOP basis, by, e.g., estimating on the fly and/or using already pre-selected filtering parameters) the filter for each category, and passes control to a function block 825. Regarding the function block 820, as an example, a directional filter is estimated for anisotropic pixels, while a non-directional filter is estimated for isotropic pixels. The function block 825 filters pixels based on corresponding filters, and passes control to a loop limit block 830. The loop limit block 830 loops over each region in a current picture, and passes control to a function block 835. The function block 835 checks if the region is suitable for filtering based on RDcost (rate-distortion cost), and passes control to a function block 840. The function block 840 sets is_alf_filter=0/1 based on the RD decision results, and passes control to a loop limit block 845. The loop limit block 845 ends the loop over each region, and passes control to a function block 850. The function block 850 encodes filter coefficients for each category, encodes is_alf_filter for each region, and passes control to an end block 899.

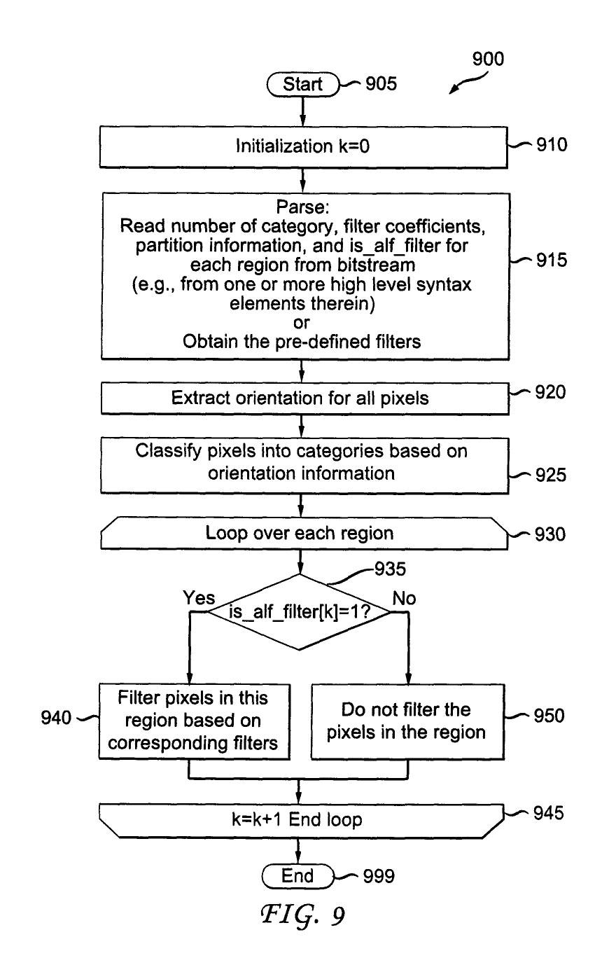

Turning to FIG. 9, another exemplary method for adaptive directional filtering in a video decoder is indicated generally by the reference numeral 900. The method 900 includes a start block 905 that passes control to a function block 910. The function block 910 performs an initialization, setting a variable k=0, and passes control to a function block 915. The function block 915 performs parsing, including reading the number of categories, the filter coefficients, partition information, and is_alf_filter for each region from the bitstream or obtains the pre-defined filters, and passes control to a function block 920. That is, regarding function block 915, either the parsing is performed or the pre-defined filters are obtained. The function block 920 extracts the orientation for all pixels, and passes control to a function block 925. The function block 925 classifies pixels into categories based on orientation information, and passes control to a loop limit block 930. The loop limit block 930 loops over each region, and passes control to a decision block 935. The decision block 935 determines whether or not is_alf_filter[k] is equal to 1. If so, then control is passed to a function block 940. Otherwise, control is passed to a function block 950. The function block 940 filters pixels in this region based on corresponding filters, and passes control to a loop limit block 945. The loop limit block 945 increments the variable k so that k=k+1, ends the loop over each region, and passes control to an end block 999. The function block 945 decides to not filter the pixels in this region, and passes control to the loop limit block 945.

A description will now be given of some of the many attendant advantages/features of the present invention, some of which have been mentioned above. For example, one advantage/feature is an apparatus having a video encoder for encoding at least a portion of a picture by categorizing pixels in the portion into respective ones of a plurality of groups, and selecting on a pixel basis filtering parameters for filtering the pixels responsive to the respective ones of the plurality of groups to which the pixels belong.

Another advantage/feature is the apparatus having the video encoder as described above, wherein the pixels are categorized responsive to respective orientations thereof.

Yet another advantage/feature is the apparatus having the video encoder wherein the pixels are categorized responsive to respective orientations thereof as described above, wherein the respective orientations are determined using at least one of a Gaussian Structure Tensor, a gradient, a variance, and a Laplacian measurement.

Still another advantage/feature is the apparatus having the video encoder as described above, wherein a particular pixel from among the pixels is respectively categorized responsive to whether the particular pixel is an anisotropic pixel and an orientation of the particular pixel.

A further advantage/feature is the apparatus having the video encoder as described above, wherein the filtering parameters include filter coefficients, and the filter coefficients for at least one of the plurality of groups is pre-selected.

Moreover, another advantage/feature is the apparatus having the video encoder as described above, wherein the filtering parameters include filter coefficients, and the filter coefficients for at least one of the plurality of groups are determined on-the-fly during the encoding.

Further, another advantage/feature is the apparatus having the video encoder as described above, wherein the filtering parameters include filter coefficients, and a set of filter coefficients is respectively estimated for each of the plurality of groups.

Also, another advantage/feature is the apparatus having the video encoder wherein the filtering parameters include filter coefficients, and a set of filter coefficients is respectively estimated for each of the plurality of groups as described above, wherein the pixels categorized into the respective ones of the plurality of groups are reconstructed pixels, and the set of filter coefficients for a particular one of the plurality of groups is estimated by minimizing a measurement criterion between the original pixels that belong to the particular one of the plurality of groups and corresponding filtered versions of the reconstructed pixels.

Additionally, another advantage/feature is the apparatus having the video encoder as described above, wherein the picture is included in a video sequence having a plurality of pictures, the filtering parameters include filter coefficients, and the filter coefficients are estimated on a frame basis or a group of pictures basis and signaled to a corresponding decoder using at least one high level syntax element.

Moreover, another advantage/feature is the apparatus having the video encoder as described above, further including filtering the pixels using the selected filtering parameters.

Further, another advantage/feature is the apparatus having the video encoder as described above, wherein the encoder determines between filtering the pixels using the selected filtering parameters or skipping the filtering of the pixels based on a block adaptive loop filter approach or a quad-tree adaptive filter approach.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a video encoder for encoding at least a portion of a picture by categorizing pixels in the portion into respective ones of a plurality of groups, and selecting on a pixel basis filtering parameters for filtering the pixels responsive to the respective ones of the plurality of groups to which the pixels belong.

2. The apparatus of claim I, wherein the pixels are categorized responsive to respective orientations thereof.

3. The apparatus of claim 2, wherein the respective orientations are determined using at least one of a Gaussian Structure Tensor, a gradient, a variance, and a Laplacian measurement.

4. The apparatus of claim 1, wherein a particular pixel from among the pixels is respectively categorized responsive to whether the particular pixel is an anisotropic pixel and an orientation of the particular pixel.

5. The apparatus of claim I, wherein the filtering parameters comprise filter coefficients, and the filter coefficients for at least one of the plurality of groups is pre-selected.

6. The apparatus of claim 1, wherein the filtering parameters comprise filter coefficients, and the filter coefficients for at least one of the plurality of groups are determined on-the-fly during the encoding.

7. The apparatus of claim 1, wherein the filtering parameters comprise filter coefficients, and a set of filter coefficients is respectively estimated for each of the plurality of groups.

8. The apparatus of claim 7, wherein the pixels categorized into the respective ones of the plurality of groups are reconstructed pixels, and the set of filter coefficients for a particular one of the plurality of groups is estimated by minimizing a measurement criterion between the original pixels that belong to the particular one of the plurality of groups and corresponding filtered versions of the reconstructed pixels.

9. The apparatus of claim 1, wherein the picture is comprised in a video sequence having a plurality of pictures, the filtering parameters comprise filter coefficients, and the filter coefficients are estimated on a frame basis or a group of pictures basis and signaled to a corresponding decoder using at least one high level syntax element.

10. The apparatus of claim 1, further comprising filtering the pixels using the selected filtering parameters.

11. The apparatus of claim 1, wherein said encoder determines between filtering the pixels using the selected filtering parameters or skipping the filtering of the pixels based on a block adaptive loop filter approach or a quad-tree adaptive filter approach.

12. In a video encoder, a method, comprising:
encoding at least a portion of a picture,
wherein said encoding step comprises:
categorizing pixels in the portion into respective ones of a plurality of groups; and
selecting on a pixel basis filtering parameters for filtering the pixels responsive, to the respective ones of the plurality of groups to which the pixels belong.

13. The method of claim 12, wherein the pixels are categorized responsive to respective orientations thereof.

14. The method of claim 13, wherein the respective orientations are determined using at least one of a Gaussian Structure Tensor, a gradient, a variance, and a Laplacian measurement.

15. The method of claim 12, wherein a particular pixel from among the pixels is respectively categorized responsive to whether the particular pixel is an anisotropic pixel and an orientation of the particular pixel.

16. The method of claim 12, wherein the filtering parameters comprise filter coefficients, and the filter coefficients for at least one of the plurality of groups is pre-selected.

17. The method of claim 12, wherein the filtering parameters comprise filter coefficients, and the filter coefficients for at least one of the plurality of groups are determined on-the-fly during the encoding.

18. The method of claim 12, wherein the filtering parameters comprise filter coefficients, and a set of filter coefficients is respectively estimated for each of the plurality of groups.

19. The method of claim 18, wherein the pixels categorized into the respective ones of the plurality of groups are reconstructed pixels, and the set of filter coefficients for a particular one of the plurality of groups is estimated by minimizing a measurement criterion between the original pixels that belong to the particular one of the plurality of groups and corresponding filtered versions of the reconstructed pixels.

20. The method of claim 12, wherein the picture is comprised in a video sequence having a plurality of pictures, the filtering parameters comprise filter coefficients, and the filter coefficients are estimated on a frame basis or a group of pictures basis and signaled to a corresponding decoder using at least one high level syntax element.

21. The method of claim 12, further comprising filtering the pixels using the selected filtering parameters.

22. The method of claim 12, wherein said encoding step comprises determining between filtering the pixels using the selected filtering parameters or skipping the filtering of the pixels based on a block adaptive loop filter approach or a quad-tree adaptive filter approach.

23. An apparatus, comprising:
a video decoder for decoding at least a portion of a picture by categorizing pixels in the portion into respective ones of a plurality of groups, and determining on a pixel basis filtering parameters for filtering the pixels responsive to the respective ones of the plurality of groups to which the pixels belong.

24. The apparatus of claim 23, wherein the pixels are categorized responsive to respective orientations thereof.

25. The apparatus of claim 24, wherein the respective orientations are determined using at least one of a Gaussian Structure Tensor, a gradient, a variance, and a Laplacian measurement.

26. The apparatus of claim 23, wherein a particular pixel from among the pixels is respectively categorized responsive to whether the particular pixel is an anisotropic pixel and an orientation of the particular pixel.

27. The apparatus of claim 23, wherein the filtering parameters comprise filter coefficients, and the filter coefficients for at least one of the plurality of groups is pre-determined.

28. The apparatus of claim 23, wherein the portion of the picture is decoded from a bitstream, the filtering parameters comprise filter coefficients, and the filter coefficients for at least one of the plurality of groups is determined from the bitstream.

29. The apparatus of claim 23, wherein the portion of the picture is decoded from a bitstream, the filtering parameters comprise filter coefficients, and the filter coefficients are determined from at least one high level syntax element residing in the bitstream.

30. The apparatus of claim 23, further comprising filtering the pixels using the determined filtering parameters.

31. The apparatus of claim wherein said decoder determines between filtering the pixels using the determined filtering parameters or skipping the filtering of the pixels based on a block adaptive loop filter approach or a quad-tree adaptive filter approach,

32. in a video decoder, a method, comprising:
decoding at least a portion of a picture,
wherein said decoding step comprises:
categorizing pixels in the portion into respective ones of a plurality of groups, and
determining on a pixel basis filtering parameters for filtering the pixels responsive to the respective ones of the plurality of groups to which the pixels belong.

33. The method of claim 32, wherein the pixels are categorized responsive to respective orientations thereof.

34. The method of claim 33, wherein the respective orientations are determined using at least one of a Gaussian Structure Tensor, a gradient, a variance, and a Laplacian measurement.

35. The method of claim 32, wherein a particular pixel from among the pixels is respectively categorized responsive to whether the particular pixel is an anisotropic pixel and an orientation of the particular pixel.

36. The method of claim 32, wherein the filtering parameters comprise filter coefficients, and the filter coefficients for at least one of the plurality of groups is pre-determined.

37. The method of claim 32, wherein the portion of the picture is decoded from a bitstream, the filtering parameters comprise filter coefficients, and the filter coefficients for at least one of the plurality of groups is determined from the bitstream.

38. The method of claim 32, wherein the portion of the picture is decoded from a bitstream, the filtering parameters comprise filter coefficients, and the filter coefficients are determined from at least one high level syntax element residing in the bitstream.

39. The method of claim 32, further comprising filtering the pixels using the determined filtering parameters.

40. The method of claim 32, wherein said decoding step comprises determining between filtering the pixels using the determined filtering parameters or skipping the filtering of the pixels based on a block adaptive loop filter approach or a quad-tree adaptive filter approach.

41. A computer readable storage media having video signal data encoded thereupon, comprising:
at least a portion of a picture encoded by categorizing pixels in the portion into respective ones of a plurality of groups, and selecting on a pixel basis filtering parameters for filtering the pixels responsive to the respective ones of the plurality of groups to which the pixels belong.
